(19) United States
(12) Patent Application Publication
(10) Pub. No.: US 2010/0225842 A1
(43) Pub. Date: Sep. 9, 2010

(54) LIQUID CRYSTAL DISPLAY INCLUDING STEP-DOWN CAPACITOR

(75) Inventors: Myung-Koo HUR, Cheonan-si, (KR); Cheol-Gon LEE, Cheonan-si (KR); Yoon-Sung UM, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si, (KR)

(21) Appl. No.: 12/534,261

(22) Filed: Aug. 3, 2009

(30) Foreign Application Priority Data
Mar. 5, 2009 (KR) 10-2009-0018994

(51) Int. Cl. G02F 1/1368; G02F 1/1343

(52) U.S. Cl. 349/48; 349/39

(57) ABSTRACT

A liquid crystal display includes; first sub-pixel electrodes and second sub-pixel electrodes, a plurality of first thin film transistors connected to the first sub-pixel electrode, a plurality of second thin film transistors connected to the second sub-pixel electrode, a plurality of third thin film transistors connected to the second sub-pixel electrode, a plurality of first gate lines connected to the first and second thin film transistors, a plurality of data lines connected to the first and second thin film transistors, a plurality of second gate lines connected to the third thin film transistors, and a capacitor electrode line including a capacitor electrode which is vertically aligned the drain electrodes of the third thin film transistors, wherein the capacitor electrode line is applied with a voltage that is less than a minimum value of a voltage applied to the data line or more than a maximum value thereof.

This application claims priority to Korean Patent Application No. 10-2009-0018994, filed on Mar. 5, 2009, and all the benefits accruing therefrom under 35 U.S.C. §119, the content of which in its entirety is herein incorporated by reference.

### BACKGROUND OF THE INVENTION

(a) Field of the Invention

The present invention relates to a liquid crystal display.

(b) Description of the Related Art

A liquid crystal display (“LCD”) is one of the most widely used types of flat panel displays (“FPD”), and it is composed of two display panels on which electric field generating electrodes, such as pixel electrodes and a common electrode, are formed, and a liquid crystal layer interposed between the two display panels. Voltages are applied to the electric field generating electrodes to generate an electric field throughout the liquid crystal layer, and the alignment of liquid crystal molecules of the liquid crystal layer is determined by the electric field. Accordingly, the polarization of incident light is controlled as it passes through the liquid crystal layer, thereby enabling the display of images.

The typical LCD also includes switching elements connected to the respective pixel electrodes, and a plurality of signal lines such as gate lines and data lines for controlling the operation of the switching elements and applying voltages to the pixel electrodes.

Among the various types of LCDs, a vertical alignment (“VA”) mode LCD, which aligns LC molecules such that their long axes are substantially perpendicular to the two display panels in the absence of an electric field, is spotlighted because of its high contrast ratio and wide reference viewing angle. In this case, the reference viewing angle refers to a viewing angle at which a contrast ratio is 1:10 or a luminance inversion limit angle between grays.

In order to provide side visibility which is roughly equal to front visibility in the vertical alignment mode LCD, a method of causing a difference in transmittance by dividing one pixel into two sub-pixels and applying different voltages to the two sub-pixels has been suggested.

An example of the method includes applying the same voltage to two sub-pixels and dropping the voltage of one sub-pixel using a separate switching element. In this structure, when the semiconductor layer is disposed under the data conductor, the capacitance of the capacitor is not uniform due to the semiconductor layer such that it is difficult to correctly control the voltage of the two sub-pixel electrodes.

### BRIEF SUMMARY OF THE INVENTION

The present invention correctly controls the voltage of two sub-pixel electrodes although a semiconductor layer is disposed under a data conductor.

An exemplary embodiment of a liquid crystal display includes; a plurality of pixel electrodes, each pixel electrode of the plurality of pixel electrodes respectively including a first sub-pixel electrode and a second sub-pixel electrode, a plurality of first thin film transistors, each of the plurality of first tin-film transistors connected to at least one first sub-pixel electrode, a plurality of second thin film transistors, each of the plurality of third thin film transistors connected to at least one second sub-pixel electrode, a plurality of third thin film transistors, each of the plurality of third thin film transistors connected to at least one second sub-pixel electrode, a plurality of first gate lines respectively connected to the plurality of first thin film transistors and the plurality of second thin film transistors, a plurality of data lines respectively connected to the plurality of first thin film transistors and the plurality of second thin film transistors, a plurality of second gate lines respectively connected to the plurality of third thin film transistors, and a capacitor electrode line including a capacitor electrode which is vertically aligned with the drain electrodes of the plurality of third thin film transistors, wherein the capacitor electrode line is applied with one of a voltage that is less than a minimum value of a voltage applied to the data line and a voltage that is greater than a maximum value of the voltage applied to the data line.

In one exemplary embodiment, a semiconductor disposed in vertical alignment with the first thin film transistor, the second thin film transistor, the drain electrode of the second thin film transistor, and the data line may be further included, and the semiconductor may have substantially the same planar shape as the first thin film transistor, the second thin film transistor, and the drain electrode of the second thin film transistor, excluding a channel of the first, second, and third thin film transistors.

In one exemplary embodiment, the capacitor electrode line may be disposed within a same layer as the first gate line and the second gate line, and may include substantially the same material as the first and second gate lines.

In one exemplary embodiment, the semiconductor may include an organic semiconductor.

In one exemplary embodiment, a passivation layer may be disposed between the pixel electrode and the data line and include a contact hole, and the passivation layer may include an organic insulator.

In one exemplary embodiment, the organic insulator may include a color filter.

In one exemplary embodiment, the first and second sub-pixel electrodes may respectively include a plurality of branches having edges oriented in different directions.

In one exemplary embodiment, the edges of the branches may form an angle of one of about 45° and about 135° with respect to the first and second gate lines.

In one exemplary embodiment, the capacitor electrode line may be applied with a voltage that is less than or greater than a common voltage.

In one exemplary embodiment, the pixel electrode may have a first domain divider.

In one exemplary embodiment, the first domain divider may be a cutout.

In one exemplary embodiment, a common electrode facing the pixel electrode may be further included, and the common electrode may have a second domain divider.

In one exemplary embodiment, the second domain divider may be a cutout.

Another exemplary embodiment of a liquid crystal display according to the present invention includes; a substrate, a gate conductor disposed on the substrate and including a capacitor voltage line having a capacitor electrode, and a first gate electrode, a second gate electrode and third gate electrode, a gate insulating layer disposed on the gate conductor, a semiconductor layer disposed on the gate insulating layer, an ohmic contact layer disposed on the semiconductor layer, a data conductor disposed on the ohmic contact layer, and including a first source electrode, a second source electrode and a third source electrode and a first drain electrode, a second drain electrode, and a third drain electrode, a passivation layer disposed on the data conductor, and a pixel electrode disposed on the passivation layer, wherein the capacitor electrode is vertically aligned with the third drain electrode, and the capacitor electrode line is applied with a voltage that is one of less than a minimum value of a voltage applied to the pixel electrode and more than a maximum value of the voltage applied to the data line.

In one exemplary embodiment, the semiconductor may have substantially the same planar shape as the data conductor except for a first exposed portion located between the first source electrode and the first drain electrode, a second exposed portion located between the second source electrode and the second drain electrode, and a third exposing portion between the first source electrode and the first drain electrode among the semiconductor.

Accordingly, a step-down capacitor is formed using the gate conductor and the data conductor such that it is not necessary to add a process for forming the step-down capacitor, thereby simplifying the manufacturing process of the liquid crystal display, and simultaneously, the capacitance of the step-down capacitor may be uniformly controlled by controlling the voltage applied to the capacitor electrode through the capacitor voltage line even though a semiconductor layer exists in the step-down capacitor Cstd, and thereby the voltages of the two sub-pixel electrodes may be correctly controlled. Also, the side visibility may be close to the front visibility.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a block diagram of an exemplary embodiment of a liquid crystal display (“LCD”) according to the present invention;

FIG. 2 is a schematic cross-sectional view illustrating a structure of the exemplary embodiment of a liquid crystal display according to the present invention and an equivalent circuit of two sub-pixels;

FIG. 3 is an equivalent circuit diagram of an exemplary embodiment of a pixel of the exemplary embodiment of an LCD according to the present invention;

FIG. 4 is a top plan layout view of an exemplary embodiment of a liquid crystal panel assembly according to the present invention;

FIG. 5 is a top plan layout view of an exemplary embodiment of a pixel electrode in an exemplary embodiment of a liquid crystal panel assembly according to the present invention;

FIG. 6 and FIG. 7 are cross-sectional views of the exemplary embodiment of a liquid crystal panel assembly shown in FIG. 4 taken along lines VI-VI and VII-VII, respectively;

FIGS. 8A, 8B and 8C are graphs showing capacitance of an exemplary embodiment of a step-down capacitor according to the present invention; and

FIG. 9 is a top plan layout view of another exemplary embodiment of a liquid crystal panel assembly according to the present invention.

### DETAILED DESCRIPTION OF THE INVENTION

The present invention will be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

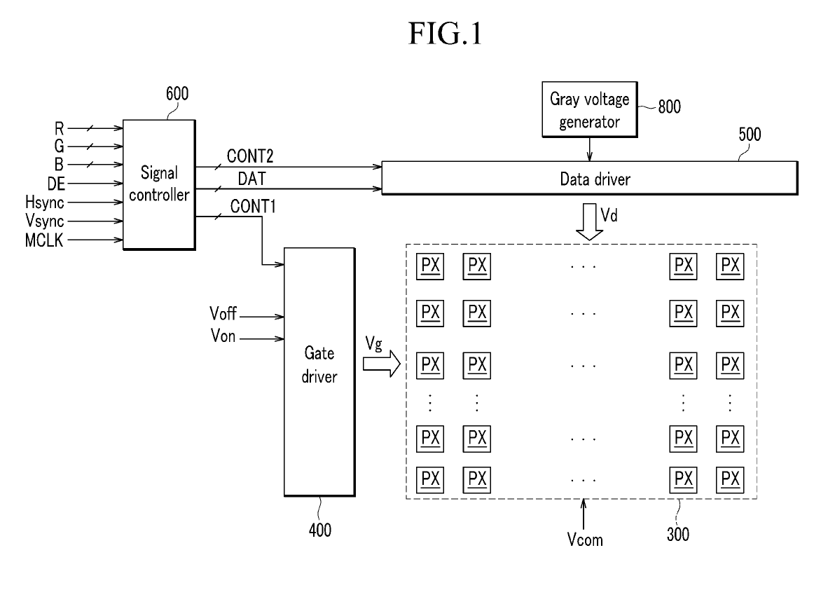

An exemplary embodiment of an LCD according to the present invention will be described more fully herein with reference to FIG. 1 to FIG. 3.

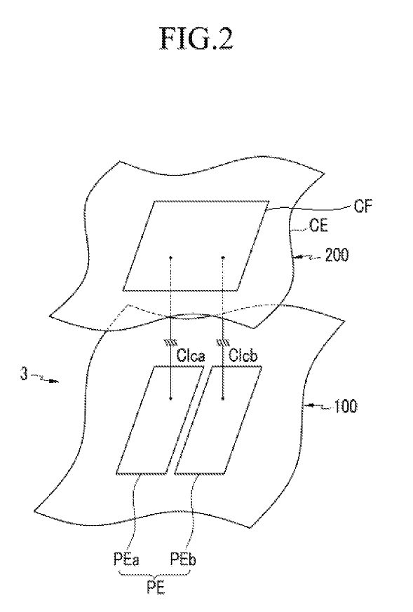

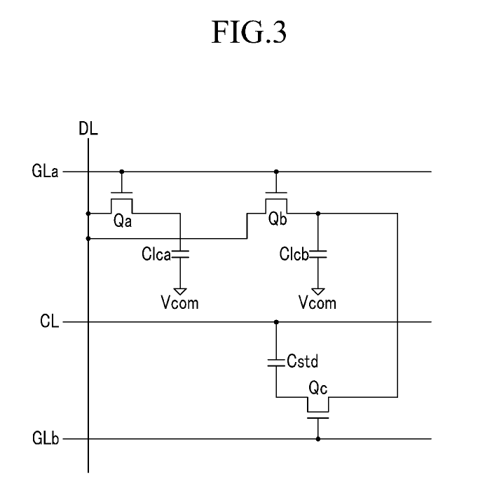

FIG. 1 is a block diagram of an exemplary embodiment of an LCD according to the present invention, FIG. 2 is a cross-sectional schematic view illustrating a structure of the exemplary embodiment of an LCD according to the present invention and an equivalent circuit of two sub-pixels, and FIG. 3 is an equivalent circuit diagram of an exemplary embodiment of a pixel of the LCD according to the present invention.

As shown in FIG. 1, an exemplary embodiment of a liquid crystal display according to the present invention includes a liquid crystal panel assembly 300, a gate driver 400, a data driver 500, a gray voltage generator 800, and a signal controller 600.

Referring to FIG. 3, the liquid crystal panel assembly 300 includes a plurality of signal lines GLa, GLb, DL, and CL, and a plurality of pixels PX that are connected thereto and arranged approximately in a matrix form. Meanwhile, as seen from the structure of FIG. 2, the liquid crystal panel assembly 300 includes a lower panel 100 and an upper panel 200 facing each other, and a liquid crystal layer 3 interposed therebetween.

Referring to FIG. 3, the signal lines include a plurality of gate lines GLa and GLb transmitting a gate signal (also referred to as a “scanning signal”), a plurality of data lines DL transmitting a data voltage Vd, and a plurality of capacitor electrode lines CL (also referred to as “storage electrode lines”) transmitting a common voltage Vcom. In the present exemplary embodiment, the gate lines GLa and GLb and the capacitor electrode lines CL extend in an approximately row-like direction and run substantially parallel to one another, and the data lines DL extend in an approximately column-like direction and run substantially parallel to each other.

The present exemplary embodiment of a liquid crystal panel assembly 300 includes a plurality of pixels PX connected to the signal lines. Each of the pixels PX includes a pair of sub-pixels, and each sub-pixel includes a liquid crystal capacitor Clca or Clcb. The two sub-pixels include switching elements Qa, Qb, and Qc connected to the gate lines GLa and GLb, the data line DL, and the liquid crystal capacitors Clca and Clcb.

The liquid crystal capacitors Clca and Clcb include sub-pixel electrodes PEa and Peb of the lower display panel 100 and a common electrode CE of the upper display panel 200 as two terminals thereof, respectively, and the liquid crystal layer 3 disposed between the sub-pixel electrodes PEa and PEb and the common electrode CE serves as a dielectric material of the liquid crystal capacitors Clca and Clcb. A pair of sub-pixel electrodes PEa and PEb that are separated from each other form one pixel electrode PE. In the present exemplary embodiment, the common electrode CE is formed on the entire surface of the upper display panel 200, and a common voltage Vcom is applied to the common electrode CE. Alternative exemplary embodiments include configurations wherein the common electrode CE does not extend over the entire surface of the upper display panel 200. In the present exemplary embodiment, the liquid crystal layer 3 has negative dielectric anisotropy, and liquid crystal molecules of the liquid crystal layer 3 may be aligned such that their major axes are substantially perpendicular to the surfaces of the two display panels when an electric field is not applied thereto. In an alternative exemplary embodiment from that illustrated in FIG. 2, the common electrode CE may be formed on the lower display panel 100, and at least one of the two electrodes PE and CE may have a linear shape or a bar shape.

Meanwhile, in order to realize color display, each pixel PX uniquely displays one of a set of primary colors (spatial division) or each pixel PX temporally and alternately displays primary colors (temporal division). Then, the primary colors are spatially or temporally synthesized, and thus a desired color is recognized. Exemplary embodiments of the primary colors may include three primary colors of red, green, and blue. FIG. 2 shows an exemplary embodiment of the spatial division in order to realize color display. In FIG. 2, each pixel PX has a color filter CF that is disposed above or below the sub-pixel electrodes Pea and PEb and represents one of the primary colors in a region of the upper panel 200. However, in an alternative exemplary embodiment of a liquid crystal display according to the present invention, the color filter may be formed in a region of the lower panel 100.

Polarizers (not shown) for providing light polarization are provided on outer surfaces of the display panels 100 and 200, and the polarization axes of the two polarizers may be substantially orthogonal. Exemplary embodiments include configurations wherein one of the two polarizers may be omitted in the case of a reflective liquid crystal display. In one of the exemplary embodiments including orthogonal polarizers, the light incident to the liquid crystal layer 3 may be blocked when an electric field is not applied, although alternative exemplary embodiments may include alternative configurations.

Referring again to FIG. 1, the gray voltage generator 800 generates all gray voltages or a predetermined number of the gray voltages (or reference gray voltages) related to a transmittance value of the pixels PX. The (reference) gray voltages may include one set having a positive value with respect to a common voltage Vcom, and another set having a negative value with respect to the common voltage Vcom.

The gate driver 400 is connected to the gate line GLa and GLb of the liquid crystal panel assembly 300, and applies gate signals obtained by combining a gate-on voltage Von and a gate-off voltage Voff to the gate lines GLa and GLb.

The data driver 500 is connected to the data lines DL of the liquid crystal panel assembly 300, and selects the data signals from the gray voltage generator 800 to apply them to the data lines DL as data voltages. However, in an exemplary embodiment wherein the gray voltage generator 800 does not supply a voltage for all grays but supplies only a predetermined number of reference gray voltages, the data driver 500 divides the reference gray voltages to generate additional grays to select image data signals. In one exemplary embodiment the data driver 500 may include a string of resistors as a voltage divider in order to generate additional gray voltages.

The signal controller 600 controls the gate driver 400 and the data driver 500.

In one exemplary embodiment, each of the drivers 400, 500 and 600 and the gray voltage generator 800 may be directly mounted on the liquid crystal panel assembly 300 in the form of at least one integrated circuit (“IC”) chip, may be mounted on a flexible printed circuit film (“FPCF”) (not shown) and then mounted on the liquid crystal panel assembly 300 in the form of a tape carrier package (“TCP”), or may be mounted on a separate printed circuit board (“PCB”) (not shown). Alternative exemplary embodiments include configurations wherein the drivers 400, 500 and 600 and the gray voltage generator 800 may be integrated with the liquid crystal panel assembly 300 together with, for example, the signal lines GLa, GLb, and DL and the thin film transistor switching elements Qa, Qb, and Qc. The drivers 400, 500 and 600 and the gray voltage generator 800 may be integrated into a single chip. In such an alternative exemplary embodiment, at least one of the drivers or at least one circuit forming the drivers may be arranged outside the single chip.

An exemplary embodiment of a liquid crystal panel assembly according to the present invention will now be described in detail with reference to FIG. 3 to FIG. 7.

Referring to FIG. 3, the exemplary embodiment of a liquid crystal panel assembly includes signal lines including neighboring first and second gate lines GLa and GLb, a data line DL, and a capacitor electrode line CL, and a plurality of pixels PX that are connected to the signal lines.

The pixel PX includes the first, second, and third switching elements Qa, Qb, and Qc, the first and second liquid crystal capacitors Clca and Clcb, and a step-down capacitor Cstd. In the present exemplary embodiment, the first and second switching elements Qa and Qb are respectively connected to the first gate line GLa and the data line DL, and the third switching element Qc is connected to the second gate line GL.

In the present exemplary embodiment, the first and second switching elements Qa and Qb are three terminal elements, exemplary embodiments of which include thin film transistors provided in the lower panel 100, the control terminals of which are connected to one of the first gates line GLa, the input terminals of which are connected to the data line DL, and the output terminals of which are respectively connected to the first/second liquid crystal capacitors Clca/Clcb.

In the present exemplary embodiment, the third switching element Qc is also a three terminal element, exemplary embodiments of which include a thin film transistor provided in the lower panel 100, the control terminal of which is connected to one of the second gate lines GLb, the input terminal of which is connected to the second liquid crystal capacitor Clcb, and the output terminal of which is connected to the step-down capacitor Cstd.

The step-down capacitor Cstd is connected to the output terminal of the third switching element Qc and the capacitor electrode line CL, and is formed by overlapping the capacitor electrode line CL provided in the lower panel 100 and the output electrode of the third switching element Qc with a layer of insulator disposed therebetween as will be described in more detail below.

A voltage applied to the capacitor electrode line CL of the exemplary embodiment of a liquid crystal display according to the present invention may be a voltage that is out of the range of the voltage applied to the first/second liquid crystal capacitor Clca/Clcb through the data line DL, and in detail, may be less than the minimum value of the voltage applied to the first/second liquid crystal capacitor Clca/Clcb through the data line DL or more than the maximum thereof. For example, in one exemplary embodiment, the voltage may be lower than a negative inversion voltage and may be higher than a positive inversion voltage when the voltage applied to the first/the second liquid crystal capacitor Clca/Clcb through the data line DL is varied between about 0V and about 14V, and when the voltage input to one terminal of the first/second liquid crystal capacitors Clca/Clcb is about 7V, the voltage applied to the capacitor electrode line CL may be less than about 0V or more than about 14V.

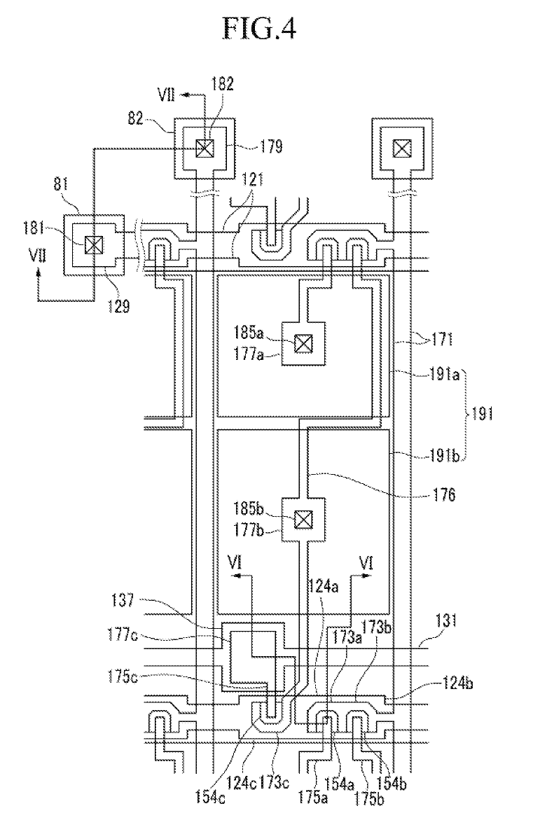

Now, the exemplary embodiment of a liquid crystal panel assembly shown in FIG. 3 will be described in detail with reference to FIG. 4 to FIG. 7.

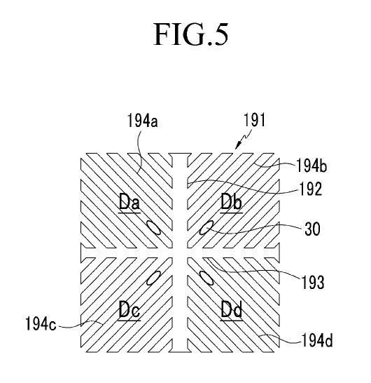

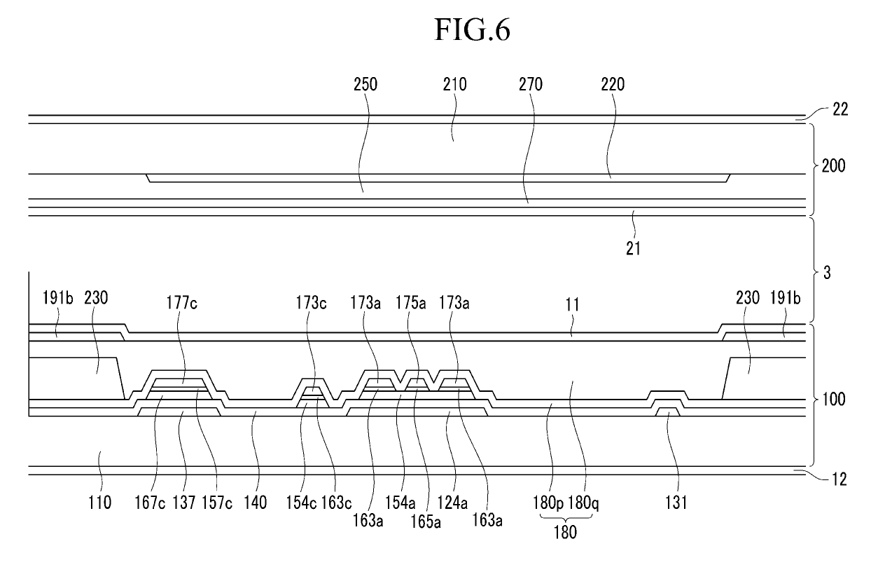

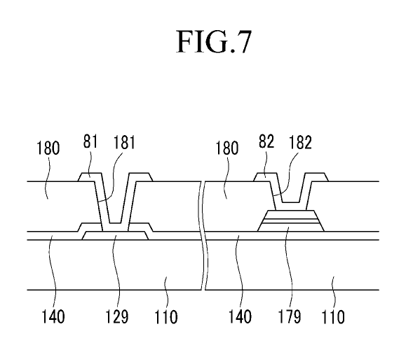

FIG. 4 is a top plan layout view of an exemplary embodiment of a liquid crystal panel assembly according to the present invention, FIG. 5 is a top plan layout view of the pixel electrode of the liquid crystal panel assembly shown in FIG. 4, and FIG. 6 and FIG. 7 are cross-sectional views of the exemplary embodiment of a liquid crystal panel assembly shown in FIG. 4 taken along the lines VI-VI and VII-VII, respectively.

The exemplary embodiment of a liquid crystal display according to the present exemplary embodiment includes the lower panel 100 and the upper panel 200 facing each other, the liquid crystal layer 3 disposed between the two display panels 100 and 200, and a pair of polarizers 12 and 22 respectively attached on the outside surfaces of the display panels 100 and 200.

Firstly, the lower panel 100 will be described. A plurality of gate conductors including gate lines 121 and capacitor electrode lines 131 are formed on an insulation substrate 110. In the present exemplary embodiment, the gate lines 121 include first, second, and third gate electrodes 124a, 124b, and 124c, and an end portion 129. Alternative exemplary embodiments include configurations wherein the end portion 129 may be omitted, e.g., when the gate lines 121 are directly connected to a gate driver 400.

The capacitor electrode lines 131 transmit a predetermined voltage, for example a capacitor voltage, and include a capacitor electrode 137 expanding upward and downward with a wide area.

A gate insulating layer 140 is formed on the gate conductors 121 and 131. A semiconductor stripe (not shown) is formed on the gate insulating layer 140. The semiconductor stripe includes a stem mainly extending in the longitudinal direction, and a plurality of first, second, and third branches 154a, 154b, and 154c extending toward the first, second, and third gate electrodes 124a, 124b, and 124c, respectively. The first, second, and third branches 154a, 154b, and 154c respectively include first to third element portions (not shown) respectively disposed on the first to third gate electrodes 124a, 124b, and 124c. The third branch 154c is extended to form a fourth branch 157c.

In one exemplary embodiment, the semiconductors 154a, 154b, 154c, and 157c may be made of an organic semiconductor. Exemplary embodiments of the organic semiconductor may include a derivative including a substituent of tetracene or pentacene, and an oligothiophene including four to eight thiophenes connected at second and fifth positions of a thiophene ring, or other materials having similar characteristics. In one exemplary embodiment, the organic semiconductor may include polythienylenevinylene, poly 3-hexylthiophene, polythiophene, phthalocyanine, metallized phthalocyanine, or their halogen derivatives. The organic semiconductor may include also include perylenetetracarboxylic dianhydride, (“PTCDA”), naphthalenetetracarboxylic dianhydride (“NTCDA”), or their imide derivatives, or other materials having similar characteristics. In one exemplary embodiment, the organic semiconductors may include perylene or coronene, and a derivative including their substituents.

An ohmic contact stripe (not shown), a first ohmic contact island 165a, a second ohmic contact island (not shown), a third ohmic contact island 163c, and a fourth ohmic contact island 167c are formed on the semiconductors 154a, 154b, 154c, and 157c. The ohmic contact stripe includes a first protrusion 163a forming a pair on either side of the first ohmic contact island 165a and disposed on the first protrusion 154a of the semiconductor, a second protrusion (not shown) forming a pair on either side of the second ohmic contact island and disposed on the second protrusion of the semiconductor, and a third protrusion (not shown) forming a pair on either side of the third ohmic contact island 163c and disposed on the third protrusion of the semiconductor.

A plurality of data conductors including a plurality of data lines 171 and a plurality of first electrode members 175a, second electrode members 176, and third electrode members 175c are formed on the ohmic contacts 163a, 165a, and 167c, and the gate insulating layer 140.

Each data line 171 includes a plurality of first and second source electrodes 173a and 173b, and an end portion 179 having a large area for contact with another layer or an external driving circuit. Alternative exemplary embodiments include configurations wherein the end portion 179 is omitted, e.g., in embodiments wherein the data lines 171 are directly connected to a data driver 500.

The first electrode member 175a forms a first drain electrode 175a, the second electrode member 176 includes a second drain electrode 175b and a third source electrode 173c that are connected to each other, and the third electrode member 175c forms a third drain electrode 175c.

The first, second, and third drain electrodes 175a, 175b, and 175c respectively include one end portion 177a, 177b, and 177c with a wide area and the other end portion of a bar type. The bar end portions of the first/second/third drain electrodes 175a/175b/175c are enclosed by the first/second/third source electrodes 173a/173b/173c. The third source electrode 173c is connected to the wide end portion 177b of the second drain electrode 175b. Alternative exemplary embodiments include alternative configurations, e.g., comb-like electrode terminals, etc.

In the present exemplary embodiment, the semiconductors 154a, 154b, 154c, and 157c have substantially the same plane shape as the data lines 171, the first to third electrode members 175a, 175b, and 175c, and the underlying ohmic contacts 163a, 165a, and 167c. However, the semiconductor stripe includes exposed portions that are not covered by the source electrodes 173a-c and the drain electrodes 175a-c, and portions that are disposed between the data lines 171 and the drain electrodes 175a-c.

In an exemplary embodiment of a manufacturing method of the thin film transistor array panel 100 according to the present invention, the data conductors 171, 175a, 175c, and 176, the semiconductors 154a-c and 157c, and the ohmic contacts 163a, 165a, and 167c are formed through one photolithography process. Alternative exemplary embodiments may include methods including additional photolithographic processes.

A photosensitive film used in this photolithography process has different thicknesses depending on positions, and particularly includes a first portion and a second portion in which the thicknesses are reduced. The first portion is located at a wiring region provided with the data line 171 and the drain electrodes 175a, 175b, and 175c, and the second portion is located at a channel region of the thin film transistor.

There are many methods of forming the difference in thicknesses according to the location of the photosensitive film. One exemplary embodiment of the method includes forming a photomask with a translucent area as well as a light transmitting area and a light blocking area. The translucent area is provided with a slit pattern or a lattice pattern, or as a thin film having medium transmittance or thickness. In the exemplary embodiment wherein a slit pattern is utilized, the slit width or the space between the slits is smaller than the resolution of exposure equipment used in the photolithography process. Another exemplary embodiment of the method includes using a reflowable photosensitive film. That is, the method forms a thin portion by making a photosensitive film flow into a region where the photosensitive film is not present after forming the reflowable photosensitive film with a general exposure mask having only a light transmitting area and a light blocking area.

Since this reduces time for the photolithography process, the manufacturing method is simplified.

The first/second/third gate electrodes 124a/124b/124c, the first/second/third source electrodes 173a/173b/173c, and the first/second/third drain electrodes 175a/175b/175c respectively form the first/second/third thin film transistors Qa/Qb/Qc along with the first/second/third semiconductor islands 154a/154b/154cd, and the channels of the thin film transistors are respectively formed in the semiconductors 154a/154b/154c between the source electrodes 173a/173b/173c and the drain electrodes 175a/175b/175c.

A lower passivation layer 180p is formed on the data conductors 171, 175a, 175b, and 175c and the exposed semiconductors 154a, 154b, and 154c. In one exemplary embodiment, the lower passivation layer 180p is made of an inorganic insulator, exemplary embodiments of which include silicon nitride or silicon oxide, and may prevent the components of color filters 230 formed thereon from being diffused into the under-lying thin film transistor.

Alternatively to the exemplary embodiment illustrated in FIG. 2, in the present exemplary embodiment a plurality of the color filters 230 are disposed on the lower passivation layer 180p. The color filters 230 may display one of a set of primary colors such as three primary colors of red, green, and blue, and may be made of an organic material including pigments displaying one of three primary colors. In the shown exemplary embodiment, the color filters 230 are formed on the lower panel 100, however, an alternative exemplary embodiment of a liquid crystal display according to the present invention may include the color filters 230 formed on the upper panel 200. Also, the illustrated exemplary embodiment includes the color filters 230 that are formed through the photolithography process, however, an alternative exemplary embodiment of a liquid crystal display of the present invention may include the color filters 230 formed through an Inkjet printing method, and in such an alternative exemplary embodiment, a partition (not shown) defining regions where ink for the color filters 230 is dripped may be added on the lower panel 100, and the partition may have the function of a light blocking member including black pigments to thereby prevent light leakage.

An upper passivation layer 180q is formed on the lower passivation layer 180p and the color filters 230. Exemplary embodiments of the upper passivation layer 180 may be made of an inorganic insulator or an organic insulator. The upper passivation layer 180q may prevent the color filters 230 from inflowing into pixel electrodes 191 or the liquid crystal layer 3, and alternative exemplary embodiments include configurations wherein the upper passivation layer 180q may be omitted.

The passivation layer 180 including the lower passivation layer 180p and the upper passivation layer 180q has a plurality of contact holes 182, 185a, and 185b respectively exposing the end portions 179 of the data lines 171, the wide end portions 177a of the first drain electrodes 175a, and the wide end portions 177b of the second drain electrodes 175b.

A plurality of pixel electrodes 191 including first and second sub-pixel electrodes 191a and 191b, and a plurality of contact assistants 81 and 82 are formed on the passivation layer 180. Exemplary embodiments of the pixel electrodes 191 and the contact assistants 81 and 82 are formed of a transparent material, exemplary embodiments of which include indium tin oxide (“ITO”) and indium zinc oxide (“IZO”).

In the present exemplary embodiment, the first and second sub-pixel electrodes 191a and 191b are adjacent to each other in the column direction, and each have the shape shown in FIG. 5. Referring to FIG. 5, the first and second sub-pixel electrodes 191a and 191b respectively include a transverse stem 193, a longitudinal stem 192 intersecting the transverse stem 193, and a plurality of first to fourth minute branches 194a, 194b, 194c, and 194d. Also, the first and second sub-pixel electrodes 191a and 191b are divided into a first sub-region Da, a second sub-region Db, a third sub-region Dc, and a fourth sub-region Dd by the transverse stem 193 and the longitudinal stem 192, and the sub-regions Da-Dd respectively include the plurality of first, second, third, and fourth minute branches 194a, 194b, 194c, and 194d. Alternative exemplary embodiments may include alternative shapes for the sub-pixel electrode 191a and 191b.

The first minute branch 194a obliquely extends from the transverse stem 193 or the longitudinal stem 192 in the upper-left direction, and the second minute branch 194b obliquely extends from the transverse stem 193 or the longitudinal stem 192 in the upper-right direction as seen from a top plan view. Also, the third minute branch 194c obliquely extends from the transverse stem 193 or the longitudinal stem 192 in the lower-left direction, and the fourth minute branch 194d obliquely extends from the transverse stem 193 or the longitudinal stem 192 in the lower-right direction as seen from a top plan view.

The first to fourth minute branches 194a-194d form an angle of about 45 degrees or 135 degrees with the gate lines 121 or the transverse stem 193. Also, the minute branches 194a-194d of two neighboring sub-regions Da-Dd may be substantially perpendicular to each other.

The first/second sub-pixel electrodes 191a/191b are connected to the first/second drain electrodes 175a/175b through the first/second contact holes 185a/185b, and receive data voltages Vd from the first/second drain electrodes 175a/175b, respectively. The first/second sub-pixel electrodes 191a/191b applied with the data voltages Vd and the common electrode 270 of the common electrode panel 200 generate an electric field that determines the orientations of liquid crystal molecules of the liquid crystal layer 3 between the sub-pixel electrodes 191a/191b and the common electrode 270. Accordingly, the luminance of the light transmitted through the liquid crystal layer 3 differs depending on the thusly determined orientation of the liquid crystal molecules.

The edges of the first to fourth minute branches 194a-194d distort the electric field, and form a horizontal component that determines an inclined direction of liquid crystal molecules 30. The horizontal component of the electric field is substantially parallel to the edges the first to fourth minute branches 194a-194d. Accordingly, the liquid crystal molecules 30 are inclined in the direction substantially parallel to the length direction of the minute branches 194a-194d. In an exemplary embodiment of the present invention, the length directions in which the minute branches 194a-194d are extended in one pixel PX are all four directions such that the inclined directions of the liquid crystal molecules 30 are all four directions. The viewing angle of the liquid crystal display is widened by varying the inclined directions of the liquid crystal molecules. Alternative exemplary embodiments include configurations wherein the length directions in which the minute branches 194a-194d are extended in one pixel PX are less than four directions.

The second sub-pixel electrode 191b is physically and electrically connected to the third source electrode 173c through the contact hole 185b. Here, the third source electrode 173c connected to the second sub-pixel electrode 191b is the third source electrode 173c disposed on the next row of the first and second drain electrodes 175a and 175b connected to the first and second sub-pixel electrodes 191a and 191b.

The capacitor electrode 137 and the wide end portion 177c of the third drain electrode 175c are aligned with each other with the gate insulating layer 140 and the semiconductor layer 157c and 167c disposed therebetween, thereby forming the step-down capacitor Cstd. That is, the step-down capacitor Cstd is formed using the gate conductor and the data conductor such that it is not necessary to add an additional process to form the step-down capacitor Cstd, thereby simplifying the manufacturing process of the liquid crystal display. In addition, in the present exemplary embodiment the area corresponding to the step-down capacitor Cstd only the gate insulating layer 140 and the semiconductor layers 157c and 167c are disposed between the two electrodes of the step-down capacitor Cstd such that the capacitance of the step-down capacitor Cstd may be further increased compared with an exemplary embodiment in which the upper layer 180q of the passivation layer 180, or the color filter 230 and the lower layer 180p of the passivation layer 180, is disposed between two electrodes.

According to an exemplary embodiment of the present invention, a voltage applied to the capacitor electrode 137 through the capacitor voltage line 131 of the liquid crystal display may be a voltage that is out of the range of the voltage applied to the first and second sub-pixel electrodes 191a and 191b through the data line 171, and in detail, may be less than the minimum value of the voltage applied to the first and second sub-pixel electrodes 191a and 191b through the data line DL or more than the maximum value of the voltage applied to the first and second sub-pixel electrodes 191a and 191b through the data line DL. For example, in one exemplary embodiment the voltage may be lower than a negative inversion voltage and may be higher than a positive inversion voltage, and when the voltage applied to the first and second sub-pixel electrodes 191a and 191b is varied between about 0V and about 14V and the voltage applied to the common electrode 270 is about 7V, the voltage applied to the capacitor voltage line 131 may be less than about 0V or more than about 14V.

When the voltage applied to the capacitor electrode 137 is controlled through the capacitor voltage line 131, although the semiconductor layer exists in the step-down capacitor Cstd, the capacitance of the step-down capacitor Cstd may be stably controlled and thereby the voltage of the two sub-pixel electrodes may be correctly controlled. This will be described in more detail later.

The contact assistants 81 and 82 are connected to the end portions 129 of the gate lines 121 and the end portions 179 of the data lines 171 through the contact holes 181 and 182, respectively. The contact assistants 81 and 82 enhance adhesion of the end portions 129 of the gate lines 121 and the end portions 179 of the data lines 171 to external devices, and protect them. As described above, exemplary embodiments include configurations wherein the gate lines 121 and/or the data lines 171 may be directly connected to the gate and data drivers 400 and 500, respectively. In such an alternative exemplary embodiment, the contact assistants 81 and 82 may be omitted.

A lower alignment layer 11 is formed on the pixel electrodes 191, the contact assistants 81 and 82, and the passivation layer 180. In one exemplary embodiment, the lower alignment layer 11 may be a vertical alignment layer.

Now, the upper panel 200 will be described in more detail. A light blocking member 220 is formed on an insulation substrate 210. The light blocking member 220 is also referred to as a black matrix, and prevents light leakage from between adjacent pixels PX and subpixels. In the present exemplary embodiment, the light blocking member 220 is formed on the upper panel, however alternative exemplary embodiments of the liquid crystal display may include the light blocking member 220 formed on the lower panel 100. Also, as above-described, when the color filters 230 are formed by the Inkjet printing method, the light blocking member 220 may be formed on the lower panel 100, thereby having the function of the partition defining the region where the ink for the color filters 230 is dripped.

An overcoat 250 is formed on the substrate 210 and the light blocking member 220. The common electrode 270 is formed on the overcoat 250. The overcoat 250 planarizes the upper panel 200 for deposition of additional components. An upper alignment layer 21 is formed on the common electrode 270. In one exemplary embodiment, the upper alignment layer 21 may be a vertical alignment layer.

In the present exemplary embodiment, the liquid crystal layer 3 has negative dielectric anisotropy, and the liquid crystal molecules 30 of the liquid crystal layer 3 may be aligned so that a major axis thereof is substantially perpendicular to the surface of the two display panels in the absence of an electric field.

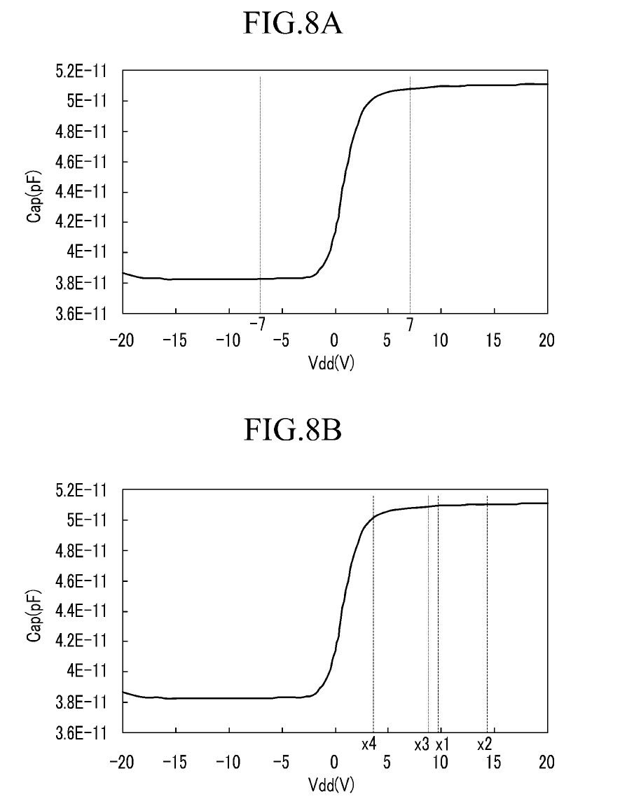

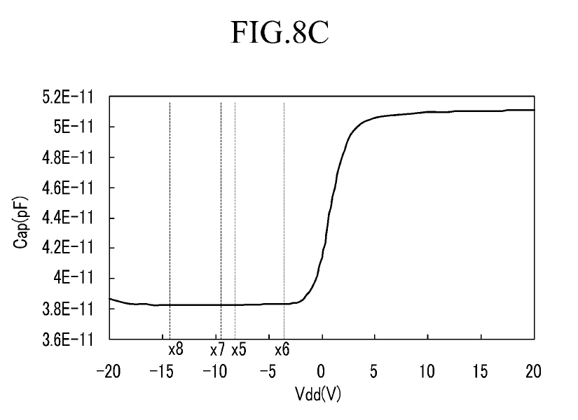

An exemplary embodiment of the operation of the LCD according to the present invention will be described hereinafter with reference to FIG. 1 to FIG. 7 as well as FIGS. 8A and 8B. FIGS. 8A and 8B are graphs showing capacitance of a step-down capacitor according to an exemplary embodiment of the present invention.

Referring first to FIG. 1, the signal controller 600 receives input image signals R, G, and B and input control signals for controlling the display from an external graphics controller (not shown). The input image signals R, G, and B involve luminance information for each pixel PX, and the luminance has a predetermined number of gray values, for example 1024=2¹⁰, 256=2⁸, or 64=2⁶ grays. Exemplary embodiments of the input control signals are a vertical synchronization signal Vsync, a horizontal synchronizing signal Hsync, a main clock signal MCLK, and a data enable signal DE.

The signal controller 600 properly processes the input image signals R, G, and B to match operating conditions of the liquid crystal panel assembly 300 based on the input image signals R, G, and B and the input control signals. Moreover, the signal controller 600 generates a gate control signal CONT1 and a data control signal CONT2, sends the gate control signal CONT1 to the gate driver 400, and sends the data control signal CONT2 and the processed image signal DAT to the data driver 500. The output image signal DAT is a digital signal and has a predetermined number of gray values.

The data driver 500 receives the digital image signal DAT for the pixel PX of one row according to the data control signal CONT2 generated by the signal controller 600, and selects a gray voltage corresponding to each digital image signal DAT. Then, the data driver 500 converts the digital image signal DAT into an analog data voltage to apply the converted digital image signal to a corresponding data line DL.

The gate driver 400 applies a gate-on voltage Von to the gate lines GLa and GLb according to the gate control signal CONT1 generated by the signal controller 600 to turn on the switching elements Qa, Qb, and Qc connected to these gate lines GLa and GLb. In one exemplary embodiment, a data voltage Vd applied to the data line DL is applied to the corresponding pixel PX through the turned-on first and second switching elements Qa and Qb.

A specific pixel row, for example focusing on the i-th pixel row, will be described below. The first gate signal is applied to the first gate line GLa of the i-th row, and the second gate line GLb is applied with the second gate signal. If the first gate signal is changed from the gate-off voltage Voff to the gate-on voltage Von, the first and second switching elements Qa and Qb connected thereto are turned on. Accordingly, the data voltage Vd applied to the data line DL is applied to the first and second sub-pixel electrodes PEa and PEb through the turned-on first and second switching elements Qa and Qb. Here, the data voltage Vd applied to the first and second sub-pixel electrodes PEa and PEb are substantially the same due to their connection to the same data line DL. The first and second liquid crystal capacitors Clca and Clcb are charged with the same value, e.g., a difference between the common voltage and the data voltage Vd.

Then, when the first gate signal is changed to the gate-off voltage Voff from the gate-on voltage Von and at the same time the second gate signal is changed to the gate-on voltage Von from the gate-off voltage Voff, the first and second switching elements Qa and Qb are turned off, and the third switching element Qc is turned on. Then, electrical charges move from the second sub-pixel electrode PEb to the third drain electrode 175c through the third switching element Qc. For this reason, the charging voltage of the second liquid crystal capacitor Clcb is lowered, and the step-down capacitor Cstd is charged with a corresponding voltage. The charging voltage of the second liquid crystal capacitor Clcb is decreased by the capacitance of the step-down capacitor Cstd such that the charging voltage of the second liquid crystal capacitor Clcb is lower than the changing voltage of the first liquid crystal capacitor Clca.

At this time, the charging voltages of two liquid crystal capacitors Clca and Clcb show different gamma curves, and the gamma curve of one pixel voltage is a curved line that is synthesized from these different gamma curves corresponding to the adjacent sub-pixels. The synthesized gamma curve as viewed from the front may be corrected so as to conform to the most suitable reference gamma curve in the front, and the synthesized gamma curve as viewed from the side may be corrected to be extremely close to the reference gamma curve as viewed from the front. As described above, due to conversion of the image data, side visibility is improved.

By repeating the above procedure over a unit of one horizontal period which is denoted by “1H” and is equal to one period of a horizontal synchronizing signal Hsync and a data enable signal DE, a data voltage Vd is applied to all pixels PXs to display an image of one frame.

When the next frame starts after finishing one frame, the state of an inversion signal RVS applied to the data driver 500 is controlled such that the polarity of the data voltage Vd applied to each pixel PX is substantially opposite to that of the previous frame. Alternative exemplary embodiments include configurations wherein an inversion signal RVS is not applied and the liquid crystal display is not inversion driven.

As described above, the charging voltages of the first and second liquid crystal capacitors Clca and Clcb may be controlled according to the capacitance of the step-down capacitor Cstd. Accordingly the correct capacitance of the step-down capacitor Cstd may be maintained.

The capacitance of an exemplary embodiment of a step-down capacitor according to the present invention will be described with reference to FIGS. 8A-C. As above-described, the step-down capacitor Cstd is formed by aligning the capacitor electrode 137 and the wide end portion 177c of the third drain electrode 175c with the gate insulating layer 140 and the underlying semiconductor layers 157c and 167c disposed therebetween.

In this way, the step-down capacitor Cstd is formed through the gate conductor and the data conductor such that the semiconductor is interposed between two terminals 137 and 177c of the capacitor, and the semiconductor may be made of the insulator or the conductor accordingly such that the capacitance of the step-down capacitor Cstd may be varied. Particularly, the capacitance may be easily varied under the inversion driving. Generally, the capacitor electrode 137 of the step-down capacitor Cstd is applied with the voltage in the range of the voltage applied to the pixel electrode 191. For example, when the common electrode 270 is applied with a voltage of about 7V and the data voltage applied to the pixel electrode 191 is changed in the range from about 0V to about 14V, the voltage applied to the capacitor electrode 137 through the capacitor voltage line 131 has a value from about 0V to about 14V, and for example is the same at about 7V as the voltage applied to the common electrode 270. In such an exemplary embodiment, the step-down voltage Vdd of the second sub-pixel electrode 191b has a lowered state due to the effect of the step-down capacitor Cstd, and is from about −7V to about 7V. However, as shown in FIG. 8A, when the step-down voltage Vdd is changed in the range of about −7V to about 7V, the capacitance Cap of the step-down capacitor Cstd is largely changed. Accordingly, it is difficult to correctly control the charged voltage of the first and second liquid crystal capacitors Clca and Clcb due to the change of the charged voltage of the second liquid crystal capacitor Clcb. That is, the voltage magnitude of the second sub-pixel electrode 191b as the low state is largely changed under the inversion driving such that serious flicker may be generated.

As shown in FIG. 8A, the region where the stepped-down voltage Vdd is less than about −3V may be an electron depletion region, and the region where the stepped-down voltage Vdd is more than about 3V may be an electron saturation region, and when the voltage Vdd is changed inside the electron depletion region or inside the electron saturation region, the capacitance Cap is not largely changed, however when the voltage Vdd is changed between the electron depletion region and the electron saturation region, the capacitance Cap is largely changed. In detail, while the accumulation of electrons is started from the region where the voltage Vdd is about −3V, and the electrons are accumulated in the saturation region to about 3V, the capacitance Cap is increased, and then becomes uniform from the electron saturation. Accordingly, when the polarity of the voltage Vdd is changed from −7V to 7V, the magnitude of the capacitance Cap is largely changed.

However, as above-described, the voltage applied to the capacitor electrode 137 of the step-down capacitor Cstd in present exemplary embodiment of a liquid crystal display of the present invention may be a voltage that is out of the range of the voltage applied to the first/second liquid crystal capacitor Clca/Clcb through the data line DL, and in detail, may be less than the minimum value of the voltage applied to the first and second sub-pixel electrodes 191a and 191b, or more than the maximum thereof. For example, the voltage may be lower than a negative inversion voltage and may be higher than a positive inversion voltage when the voltage applied to the first and the second sub-pixel electrodes 191a and 191b is varied between about 0V and about 14V, and when the voltage applied to the common electrode 270 is 7V, the voltage applied to the capacitor electrode line CL may be less than about 0V or more than about 14V. In this way, if the voltage applied to the capacitor electrode 137 of the step-down capacitor Cstd is controlled, the voltage is changed inside the electron depletion region or the electron saturation region of the step-down capacitor Cstd, and although the step-down capacitor Cstd includes the semiconductor layer, the capacitance of the step-down capacitor Cstd may be uniformly maintained under the inversion driving. Accordingly, the charging voltage of the first and second liquid crystal capacitors Clca and Clcb may be correctly controlled. This will be described with reference to FIG. 8B and FIG. 8C.

For example, the ratio of the voltage of the first sub-pixel electrode 191a and the second sub-pixel electrode 191b is determined to be 0.7 in a black state, and 0.75 in a white state. If it is assumed that the data voltage applied to the first sub-pixel electrode 191a of the high state is 1.0V at the black state, and 7.0V at the white state, the data voltage applied to the second sub-pixel electrode 191b of the low state is 0.7V at the black state, and 5.25V at the white state. Here, under the positive inversion driving, the data voltage applied to the second sub-pixel electrode 191b of the low state is 7.0V+0.7V=7.7V at the black state, and 7.0V+5.25V=12.25V at the white state, under the negative inversion driving, the data voltage applied to the second sub-pixel electrode 191b of the low state is 7.0V−0.7V=6.3V at the state black, and 7.0V−5.25V=1.75V at the white state. As above-described, the voltage applied to the capacitor electrode 137 of the liquid crystal display according to an exemplary embodiment of the present invention is out of the range of the voltage applied to the second sub-pixel electrode 191b, and in the above example, is out of the range of 1.75V to 12.25V.

For example, in an exemplary embodiment wherein it is assumed that the voltage applied to the capacitor electrode 137 is −2.0V, under the positive inversion driving, the magnitude of the stepped-down voltage Vdd of the second sub-pixel electrode 191b by the step-down capacitor Cstd is 7.7V−(−2V)=9.7V in the black state and is 12.25V−(−2V)=14.25V in the white state, under the negative inversion driving, the magnitude of the stepped-down voltage Vdd of the second sub-pixel electrode 191b by the step-down capacitor Cstd is 6.3V−(−2V)=8.3V in the black state and 1.75V−(−2V)=3.75V in the white state. In FIG. 8B, the values of the stepped-down voltage Vdd are respectively indicated by ×1, ×2, ×3, and ×4. Referring to FIG. 8B, the capacitance Cap of the step-down capacitor Cstd is uniformly maintained in the range of ×1 to ×2 of the positive inversion driving and in the range of ×3 to ×4 of the negative inversion driving. Accordingly, although the step-down capacitor Cstd includes the semiconductor layer, the capacitance of the step-down capacitor Cstd may be uniformly maintained such that the charging voltage of the first and second liquid crystal capacitors Clca and Clcb may be correctly controlled.

As another exemplary embodiment, if it is assumed that the voltage applied to the capacitor electrode 137 is 16.0V, under the positive inversion driving the magnitude of the stepped-down voltage Vdd of the second sub-pixel electrode 191b by the step-down capacitor Cstd is 7.7V−16.0V=−8.3V in the black state and 12.25V−16.0V=−3.75V in the white state, under the negative inversion driving, the magnitude of the stepped-down voltage Vdd of the second sub-pixel electrode 191b by the step-down capacitor Cstd is 6.3V−16.0V=−9.7V in the black state and 1.75V−16.0V=−14.25V in the white state. In FIG. 8C, the values of the stepped-down voltage Vdd are respectively indicated by ×5, ×6, ×7, and ×8. Referring to FIG. 8C, the capacitance Cap of the step-down capacitor Cstd is uniformly maintained in the range of ×5 to ×6 under the positive inversion driving and in the range of ×7 to ×8 under the negative inversion driving. Accordingly, although the step-down capacitor Cstd includes the semiconductor layer, the capacitance of the step-down capacitor Cstd may be uniformly maintained such that the charging voltage of the first and second liquid crystal capacitors Clca and Clcb may be correctly controlled.

In this way, the voltage applied to the capacitor electrode 137 of the step-down capacitor Cstd in the liquid crystal display according to an exemplary embodiment of the present invention may be a voltage that is out of the range of the voltage applied to the first/second liquid crystal capacitor Clca/Clcb through the data line DL, and in detail, may be less than the minimum value of the voltage applied to the first and second sub-pixel electrodes 191a and 191b or more than the maximum value of the voltage applied to the first and second sub-pixel electrodes 191a and 191b.

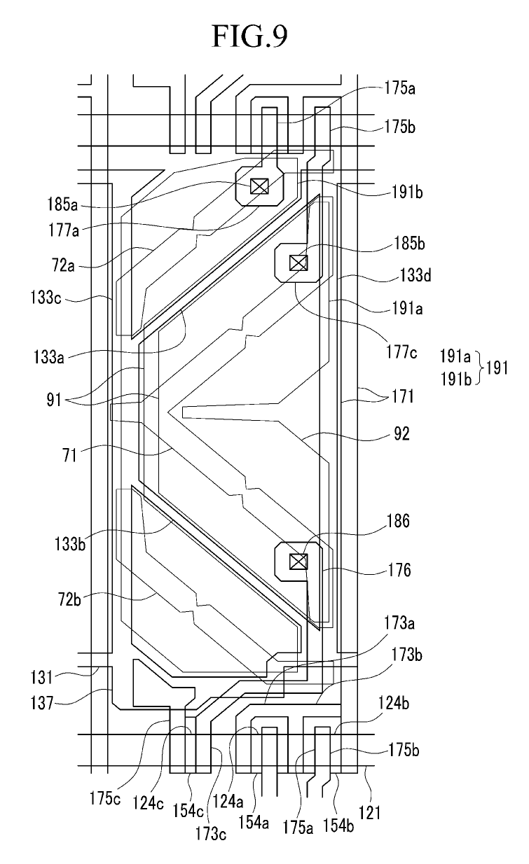

Now, another exemplary embodiment of a liquid crystal display according to the present invention will be described with reference to FIG. 9. FIG. 9 is a top plan layout view of another exemplary embodiment of a liquid crystal display according to the present invention.

Similar to the exemplary embodiment shown in FIG. 4 to FIG. 7, the present exemplary embodiment of a liquid crystal display includes two display panels 100 and 200 facing each other, and a liquid crystal layer 3 interposed between the two display panels 100 and 200. In the exemplary embodiment of a liquid crystal display shown in FIG. 9, the same constituent elements as in the previous exemplary embodiment of a liquid crystal display shown in FIG. 4 to FIG. 7 are indicated by the same reference numerals.

Referring to the lower panel 100, a gate conductor including a plurality of gate lines 121 and capacitor voltage lines 131 is formed on an insulation substrate (not shown), a gate insulating layer (not shown) is formed on the gate conductor, semiconductor layers 154a, 154b, and 154c are formed on the gate insulating layer, and an ohmic contact (not shown) is formed on the semiconductor layers 154a, 154b, and 154c. A data conductor including a plurality of data lines 171, and a plurality of first electrode members 175a, second electrode members 175b, third electrode members 175c, and connecting members 176 is formed on the ohmic contact and the gate insulating layer. In the present exemplary embodiment, the semiconductors 154a, 154b, and 154c have substantially the same plane shape as the data lines 171, the first to third electrode members 175a, 175b, and 175c, and the connecting member 176, and the underlying ohmic contact. That is, in an exemplary embodiment of the manufacturing method of the lower panel 100 according to the present invention, the data conductors 171, 175a, 175b, 175c, and 176, the semiconductors 154a-c, and the ohmic contact are formed through one photolithography process. A lower passivation layer (not shown) is formed on the data conductors 171, 175a, 175b, 175c, and 176, and the exposed semiconductors 154a-c, color filters (not shown) are formed on the lower passivation layer, and an upper passivation layer (not shown) is formed on the lower passivation layer and the color filters.

In the present exemplary embodiment, a pixel electrode 191 including first and second sub-pixel electrodes 191a and 191b is formed on the passivation layer. The first sub-pixel electrode 191a is connected to the expansion 177a of the first drain electrode 175a through a contact hole 185a of the passivation layer. The second sub-pixel electrode 191b is connected to the expansion 177b of the second drain electrode 175b through a contact hole 185b of the passivation layer, and is simultaneously connected to the expansion 176 of the third source electrode 173c through a contact hole 186.

In the present exemplary embodiment of a liquid crystal display, the wide end portion 177c of the capacitor electrode 137 and the third drain electrode 175c overlaps the step-down capacitor Cstd via the gate insulating layer and the semiconductor layer. The voltage applied to the capacitor electrode 137 through the capacitor voltage line 131 of the exemplary embodiment of a liquid crystal display may be out the range of the inversion voltage applied to the first and second sub-pixel electrodes 191a and 191b through the data line 171, and in detail may be less than the minimum value of the voltage applied to the first and second sub-pixel electrode 191a and 191b and more than the maximum value thereof. For example, in an exemplary embodiment wherein the voltage applied to the first and second sub-pixel electrodes 191a and 191b is changed in the range of about 0V to about 14V, the voltage applied to the capacitor electrode line CL may be less than about 0V or more than about 14V.

Referring to the upper panel 200, a light blocking member (not shown) is formed on an insulation substrate (not shown), and an overcoat (not shown) and a common electrode (not shown) are sequentially formed on the light blocking member.

However, as shown in FIG. 9, the shape of the capacitor voltage line 131 and the shape and arrangement of the pixel electrode 191 of the present exemplary embodiment of a liquid crystal display are different from the previous exemplary embodiments of a liquid crystal display shown in FIG. 4 to FIG. 7. Also, the common electrode of the present exemplary embodiment of a liquid crystal display has a plurality of cutouts 71, 72a, and 72b. These differences will be described in more detail below.

The capacitor voltage line 131 according to the present exemplary embodiment overlaps a gap 91 between the first sub-pixel electrode 191a and the second sub-pixel electrode 191b, and includes storage capacitance portions 133a, 133b, 133c, and 133d overlapping two neighboring data lines 171, the interval (not shown) between the first sub-pixel electrode 191a and the second sub-pixel electrode 191b, and the capacitor electrode 137 forming one terminal of the step-down capacitor Cstd.

A pair of the first and second sub-pixel electrodes 191a and 191b forming the pixel electrode 191 according to the present exemplary embodiment engage with each other with the gap 91 disposed therebetween, and the second sub-pixel electrode 191b is inserted in a central portion of the second sub-pixel electrode 191a. That is, the first sub-pixel electrode 191a has a shape enclosing the second sub-pixel electrode 191b, and they are separated by the gap 91 thereby not being overlapped to each other. The second sub-pixel electrode 191b includes a center cutout 92. The pixel electrode 191 is divided into four partitions by the gap 91 and the center cutout 92. Here, exemplary embodiments of the number of regions or cutouts may vary depending on design components, such as the size of the pixel electrode 191, the length ratio of the horizontal side and the vertical side of the pixel electrode 191, the type of liquid crystal layer 3, or other characteristics.

The present exemplary embodiment of a common electrode includes a set of the plurality of cutouts 71, 72a, and 72b. The cutouts 71, 72a, and 72b are respectively disposed between the gap 91 and the center cutout 92 of the pixel electrode 191, and extend substantially parallel to the gap 91 and the center cutout 92 in the pixel electrode 191. The number of the cutouts 71, 72a, and 72b, and the direction thereof may also be changed according to the design elements.

The gap 91 and the center cutout 92 of the pixel electrode 191 and the cutouts 71, 72a, and 72b of the common electrode 270 distort the electric field generated between the pixel electrode 191 and the common electrode and form a horizontal component for determining the inclination direction of the liquid crystal molecules. The horizontal component of the electric field is substantially perpendicular to the edges of the gap 91 and the cutouts 92, 71, 72a, and 72b, and the pixel electrode 191.

The set of the gap 91 and the cutouts 92, 71, 72a, and 72b divide the pixel electrode 191 into a plurality of sub-areas, and each sub-area has two major edges forming an oblique angle along with the main edge of the pixel electrode 191. Since the liquid crystal molecules on each sub-region tilt substantially perpendicular to the major edges, the azimuthal distribution of the tilt directions are localized to four directions. In this way, the reference viewing angle of the liquid crystal display is increased by making the tilt directions of the liquid crystal molecules various. Alternative exemplary embodiments include configurations including greater or lesser numbers of tilt directions.

In an alternative exemplary embodiment, at least one of the cutouts 92, 71, 72a, and 72b can be replaced with a protrusion or a depression, and the shape and disposition of the cutouts 92, 71, 72a, and 72b can be modified.

As above-described, the second sub-pixel electrode 191b is connected to the step-down capacitor Cstd, and a portion of the voltage charged to the second sub-pixel electrode 191b moves to the step-down capacitor Cstd through the third drain electrode 175c such that the amount of voltage charged to the second sub-pixel electrode 191b is less than the amount of voltage charged to the first sub-pixel electrode 191a. Accordingly, the charging voltages of the liquid crystal capacitor Clca and Clcb show different gamma curves, and the gamma curve of one pixel voltage is a curved line that is synthesized from these different gamma curves. The synthesized gamma curve as viewed from the front may be corrected so as to conform to the most suitable reference gamma curve in the front, and the synthesized gamma curve as viewed from the side may be corrected so as to be extremely close to the reference gamma curve as viewed from the front. As described above, due to conversion of the image data, side visibility is improved.

Like the previous exemplary embodiment, the voltage applied to the capacitor electrode 137 of the present exemplary embodiment of a liquid crystal display is less than the minimum value of the voltage applied to the pixel electrode 191 through the data line 171 and more than the maximum value of the voltage applied to the pixel electrode 191 through the data line 171. Accordingly, the capacitance of the step-down capacitor Cstd may be uniformly controlled by controlling the voltage applied to the capacitor electrode 137 through the capacitor voltage line 131 even though the semiconductor layer exists in the step-down capacitor Cstd, and thereby the voltages of the two sub-pixel electrodes may be correctly controlled.

Many characteristics of the exemplary embodiment of a liquid crystal display shown in FIG. 4 to FIG. 7 may apply to the exemplary embodiment of a liquid crystal display shown in FIG. 9.

Accordingly, in the exemplary embodiments of a liquid crystal display according to the present invention, the step-down capacitor Cstd is formed using the gate conductor and the data conductor such that it is not necessary to add the process for forming the step-down capacitor Cstd, thereby simplifying the manufacturing process of the liquid crystal display, and simultaneously, the capacitance of the step-down capacitor Cstd may be uniformly controlled by controlling the voltage applied to the capacitor electrode 137 through the capacitor voltage line 131 even though the semiconductor layer exists in the step-down capacitor Cstd such that the voltages of the two sub-pixel electrodes may be correctly controlled.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a plurality of pixel electrodes, each pixel electrode of the plurality of pixel electrodes respectively including a first sub-pixel electrode and a second sub-pixel electrode;
a plurality of first thin film transistors, each of the plurality of first thin-film transistors connected to at least one first sub-pixel electrode;
a plurality of second thin film transistors, each of the plurality of second thin film transistors connected to at least one second sub-pixel electrode;
a plurality of third thin film transistors, each of the plurality of third thin film transistors connected to at least one second sub-pixel electrode;
a plurality of first gate lines respectively connected to the plurality of first thin film transistors and the plurality of second thin film transistors;
a plurality of data lines respectively connected to the plurality of first thin film transistors and the plurality of second thin film transistors;
a plurality of second gate lines respectively connected to the plurality of third thin film transistors; and
a capacitor electrode line including a capacitor electrode which is aligned with drain electrodes of the plurality of third thin film transistors,
wherein the capacitor electrode line is applied with one of a voltage that is less than a minimum value of a voltage applied to the data line and a voltage that is greater than a maximum value of the voltage applied to the data line.

2. The liquid crystal display of claim 1, further comprising:
a semiconductor disposed in vertical alignment with the first thin film transistor, the second thin film transistor, the drain electrode of the third thin film transistor, and the data line,
wherein the semiconductor has substantially the same planar shape as the first thin film transistor, the second thin film transistor, and the drain electrode of the third thin film transistor, excluding a channel of the first thin film transistor, the second thin film transistor, and third thin film transistor.

3. The liquid crystal display of claim 2, wherein, the capacitor electrode line is disposed within a same layer as the first gate line and the second gate line.

4. The liquid crystal display of claim 3, wherein, the capacitor electrode line includes substantially the same material as the first and second gate lines.

5. The liquid crystal display of claim 2, wherein, the semiconductor includes an organic semiconductor.

6. The liquid crystal display of claim 1, further comprising:
a passivation layer disposed between the pixel electrode and the data line, and including a contact hole,
wherein the passivation layer includes an organic insulator.

7. The liquid crystal display of claim 6, wherein, the organic insulator includes a color filter.

8. The liquid crystal display of claim 1, wherein, the first sub-pixel electrode and the second sub-pixel electrode respectively include a plurality of branches having edges oriented in different directions.

9. The liquid crystal display of claim 8, wherein, the edges of the branches form an angle of one of about 45° and about 135° with respect to the first gate line and the second gate line.

10. The liquid crystal display of claim 1, wherein, the capacitor electrode line is applied with a voltage that is less or more than a common voltage.

11. The liquid crystal display of claim 1, wherein, the pixel electrode has a first domain divider.

12. The liquid crystal display of claim 11, wherein, the first domain divider means is a cutout.

13. The liquid crystal display of claim 11, further comprising:
a common electrode disposed substantially opposite to the pixel electrode,
wherein the common electrode has a second domain divider.

14. The liquid crystal display of claim 13, wherein, the second domain divider is a cutout.

15. A liquid crystal display including a plurality of pixels, the liquid crystal display comprising:
a substrate;
a gate conductor disposed on the substrate, and including a capacitor voltage line having a capacitor electrode, and a first gate electrode, a second gate electrode, and a third gate electrode;
a gate insulating layer disposed on the gate conductor;
a semiconductor layer disposed on the gate insulating layer;
an ohmic contact layer disposed on the semiconductor layer;
a data conductor disposed on the ohmic contact layer, and including a first source electrode, a second source electrode, and a third source electrode, and a first drain electrode, a second drain electrode, and third drain electrode;
a passivation layer disposed on the data conductor; and
a pixel electrode disposed on the passivation layer,
wherein the capacitor electrode is vertically aligned with the third drain electrode, and
the capacitor electrode line is applied with a voltage that is one of less than a minimum value of a voltage applied to the pixel electrode and more than a maximum value of the voltage applied to the data line.

16. The liquid crystal display of claim 15, wherein
the semiconductor has substantially the same planar shape as the data conductor except for a first exposed portion located between the first source electrode and the first drain electrode, a second exposed portion located between the second source electrode and the second drain electrode, and a third exposed portion located between the first source electrode and the first drain electrode.

17. The liquid crystal display of claim 16, wherein, the passivation layer includes an organic insulator.

18. The liquid crystal display of claim 17, wherein, the organic insulator includes a color filter.

19. The liquid crystal display of claim 15, wherein, the first sub-pixel electrode and the second sub-pixel electrode respectively include a plurality of branches having edges oriented in different directions.

20. The liquid crystal display of claim 15, wherein, the pixel electrode includes a first domain divider.
